(19) United States
(12) Patent Application Publication
(10) Pub. No.: US 2026/0169815 A1
(43) Pub. Date: Jun. 18, 2026

(54) GEO-DISTRIBUTED LANGUAGE MODEL TRAINING

(71) Applicant: Microsoft Technology Licensing, LLC, Redmond, WA (US)

(72) Inventors: Rohan GANDHI, Pune (IN); Palak, Hisar (IN); Karan TANDON, Delhi (IN); Debopam BHATTACHERJEE, Bengaluru (IN)

(21) Appl. No.: 18/984,123

(22) Filed: Dec. 17, 2024

(51) Int. Cl. G06F 9/50; H04W 84/02

(52) U.S. Cl. CPC G06F 9/5038; H04W 84/02

(57) ABSTRACT

The present disclosure relates to systems and methods for performing geo-distributed training of language models using graphics processing units in different datacenters. The systems and methods use the graphics processing units across data parallelism, pipeline parallelism, and tensor parallelism during training of the language model.

### BACKGROUND

The use of language models (LMs) across different industries has caused a huge surge in demand for graphics processing units (GPUs). Language models are seeing an explosive growth in size to continually improve the accuracy of the language models. Training language models requires tens of thousands of GPUs and housing the GPUs used in training language models in the same datacenter (DC) is a challenge.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes performing training of a language model using a plurality of graphics processing units (GPU) s in different datacenters connected via a wide area network (WAN). The method includes determining a schedule for processing data parallel pipelines of the training using available bandwidth of the WAN. The method includes processing, using the schedule, one data parallel pipeline at a time on the available bandwidth of the WAN for each datacenter until the training of the language model is complete.

Some implementations relate to a device. The device includes a memory to store data and instructions; and a processor operable to communicate with the memory, wherein the processor is operable to: perform training of a language model using a plurality of graphics processing units (GPU) s in different datacenters connected via a wide area network (WAN); determine a schedule for processing data parallel pipelines of the training using available bandwidth of the WAN; and process, using the schedule, one data parallel pipeline at a time on the available bandwidth of the WAN for each datacenter until the training of the language model is complete.

Some implementations relate to a computer-readable storage medium including instructions that, when executed by a processor, cause the processor to: perform training of a language model using a plurality of graphics processing units (GPU) s in different datacenters connected via a wide area network (WAN); determine a schedule for processing data parallel pipelines of the training using available bandwidth of the WAN; and process, using the schedule, one data parallel pipeline at a time on the available bandwidth of the WAN for each datacenter until the training of the language model is complete.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for geo-distributed training of language models in accordance with implementations of the present disclosure.

FIG. 2 illustrates an example timing diagram of temporal bandwidth sharing across data parallel pipelines in accordance with implementations of the present disclosure.

FIG. 3 illustrates an example environment for scheduling prefill phases of inference requests in accordance with implementations of the present disclosure.

FIG. 4 illustrates an example method for geo-distributed training of language models in accordance with implementations of the present disclosure.

FIG. 5 illustrates components that may be included within a computer system.

### DETAILED DESCRIPTION

This disclosure generally relates to training langue models. The widespread adoption of language models (LMs) across different industries has caused a huge surge in demand for graphics processing units (GPUs). The language models have seen a substantial increase in the number of parameters to improve the accuracy of the models and the language models also support a larger number of tokens. For example, a GPT4 model is typically a trillion parameters in size and a LlaMA model is typically 405 billion parameters in size. Training language models is a significant investment. For example, GPT4 models require 10000s of GPUs running for months for training. As the language model size grows, the compute time grows quadratically while the communication time grows linearly.

Training language models is typically done in a single datacenter (DC) that enjoys the benefits of fast interconnect. Training language models requires an increasing number of GPUs and housing the GPUs in the same datacenter is challenging due to space, power, power-density, and cooling requirements. GPUs are becoming more power-hungry, and a large number of GPUs are getting assigned to inference requests, leaving just a small number of GPUs available for training. For example, as much as 90% of GPUs in a datacenter are being assigned to inference tasks.

A training job learns the parameters of neural networks in the language model. In each training iteration, the language model takes a few samples of a data called a minibatch and performs a forward pass that computes the loss values for the data samples followed by a backward pass that computes the gradients. The model parameters are learnt by applying the negative of the gradients. The training job is typically distributed across multiple GPUs due to the massive size of language models (e.g., billions to trillions of parameters).

Training jobs use multiple forms of parallelism such as data parallelism (DP), pipeline parallelism (PP), and tensor parallelism (TP). In data parallelism (DP), the language model (or a subset of its layers) is replicated across GPUs and different minibatches are fed to such replicas. At the end of the iteration (one forward and backward pass), gradients are averaged through all-reduce where the communication between replicas is on the critical path. Data parallelism helps in speeding up the training time.

Pipeline parallelism helps in fitting larger models across GPUs. In pipeline parallelism, different layers of the model are assigned to different GPUs. One GPU sends the activations (in forward pass) to the next GPU over a network. In the backward pass, the gradients are sent between GPUs over a network. The minibatch is further split across different micro-batches that are pipelined in execution. The critical path is shaped by the slowest (due to slower communication, computation, or both) pipeline stage.

Tensor parallelism helps in fitting models across GPUs. Tensor parallelism splits individual layers across different GPUs and use all-reduce for communication. Tensor parallelism requires significantly higher network bandwidth than data parallelism and pipeline parallelism due to frequent synchronization needed across shards.

Training language models usually involves all forms of parallelism (e.g., 3D parallelism). Training language models necessitates a substantial number of GPUs to minimize training latency. Typically, training use GPUs within the same datacenter. However, consolidating all GPUs in a single datacenter is becoming increasingly challenging as many GPUs are being allocated to inference workloads and data centers are hitting a power draw and cooling thresholds due to high GPU power density.

There is a growing need for performing training of language models across different datacenters. Existing solutions use data parallelism across datacenters to distribute the training jobs across multiple datacenters. Existing solutions fall short in achieving good performance when GPUs used for the training are distributed across different datacenters. Communications needed during activation updates, gradient updates, and synchronization, incurs a significantly higher latency over inter-DC WAN than in intra-DC networks. Existing solutions typically elongate training time and have poor GPU utilization due to the bubbles in the GPUs (idle GPU time) for up to 95% of the time. Existing solutions end up with bubbles (idle GPU time) between the forward and backward passes in one training iteration, and also between micro-batches in the same minibatch. Similarly, in pipeline parallelism, the datacenters running later pipeline stages are idle (bubble) before activations are transferred from the preceding stages. The bubbles are amplified due to slow WAN communication. Consequently, existing solutions achieve less than 5% GPU utilization, and each training iteration is severely elongated. In existing solutions, the training time of language models grows as more datacenters are added. For example, in existing solutions training across different datacenters can result in an order or magnitude slower training time.

The present disclosure provides systems and methods for performing geo-distributed training of language models. Geo-distributed training is running the training of the language models in different datacenters connected via a wide-area-network (WAN). One example of a language model includes generative artificial intelligence (AI) models. Examples of generative AI models include Generative Pre-trained Transformer (GPT) models (e.g., GPT-3 or GPT-4), LlaMA, and GEMINI. Examples of generative AI models also include text-to-image models, such as, DALL-E. Generative AI models generate content, such as text, images, video, audio, or other data in response to a question or prompt. Another example of a generative AI model includes multi-modal models. In some implementations, the question or prompt is multi-modal input, and the generative AI model processes the multi-modal input to generate content. For example, the generative AI model receives non-text input and generates an output of text. Another example includes, the generative AI model receives text input and generates a non-text output. Generative AI models learn the patterns and structure of the input training data and generate new data that has similar characteristics to the input data in response to prompts. The prompt includes instructions, and the generative AI model generates a summary of the detected anomaly in response to the instructions provided in the prompt.

During training of the language model, the methods and systems split the GPUs across data parallelism, pipeline parallelism, and tensor parallelism. In some implementations, the methods and systems perform pipeline parallelism across different datacenters and perform data parallelism and tensor parallelism within a datacenter. In some implementations, the methods and systems use temporal bandwidth sharing to coordinate sharing the WAN bandwidth among the data parallelism pipelines. The present disclosure includes a number of practical applications that provide benefits and/or solve problems associated with training language models. Examples of these applications and benefits are discussed in further detail below.

One example benefit is improving training time of language models and GPU usage at the same time. By performing pipeline parallelism across datacenters and performing data parallelism and tensor parallelism within a datacenter, the training time of the language models is reduced.

Another example benefit is improving training bubbles (e.g., idle time) in the GPUs. The systems and methods use temporal bandwidth sharing to coordinate among the data parallelism pipelines to share the WAN bandwidth leading to shorter bubbles and reducing bubbles in portions of the pipelines.

In some implementations, the systems and methods use a heuristic to determine an optimal split of GPUs across datacenters and an optimal number of datacenters to use in training the language model to reduce training time and costs associated with training the language model. In some implementations, the systems and methods use multiple TCP connections to scale the bandwidth among datacenters and improve the training time.

In some implementations, the systems and methods schedule independent workloads during a bubble to reduce wastage of compute during idle times. The system and methods schedule the prefill phase of eligible inference requests to reduce bubbles (e.g., idle time) in the GPUs during the training of language models. Inference requests compose of distinct prefill (digesting the prompt before auto-regression or decode starts) and decode phases. The duration of prefill is known based on the prompt before running the prefill of inference. The systems and methods schedule the prefills based on the duration to balance the execution time and memory overheads by using pipeline parallelism for the inference model. For example, a controller receives prefill requests from the inference controller (receives the requests from the users) and the controller places the prefill requests into bubbles in the training pipeline, reducing the number of GPUs provisioned for inference.

One technical advantage of the systems and methods of the present disclosure is improving the training time of language models. For example, the systems and methods reduce the training time of language models up to 17× as compared to existing solutions. The systems and methods use multiple TCP connections among the datacenters and intelligently sharing the WAN bandwidth to improve the training time of language models. Another technical advantage of the systems and methods of the present disclosure is removing GPU idle time between micro-batches. Another technical advantage of the systems and methods of the present disclosure is improving GPU usage in training of language models. The systems and methods determine an optimal number of GPU to use in training to maximize training throughput and reduce latency. The system and methods schedule independent workloads (inference requests) for use on the GPU without interfering with training improving the GPU usage. The systems and methods train language models faster and reduce service costs by sharing the GPUs across training and inference.

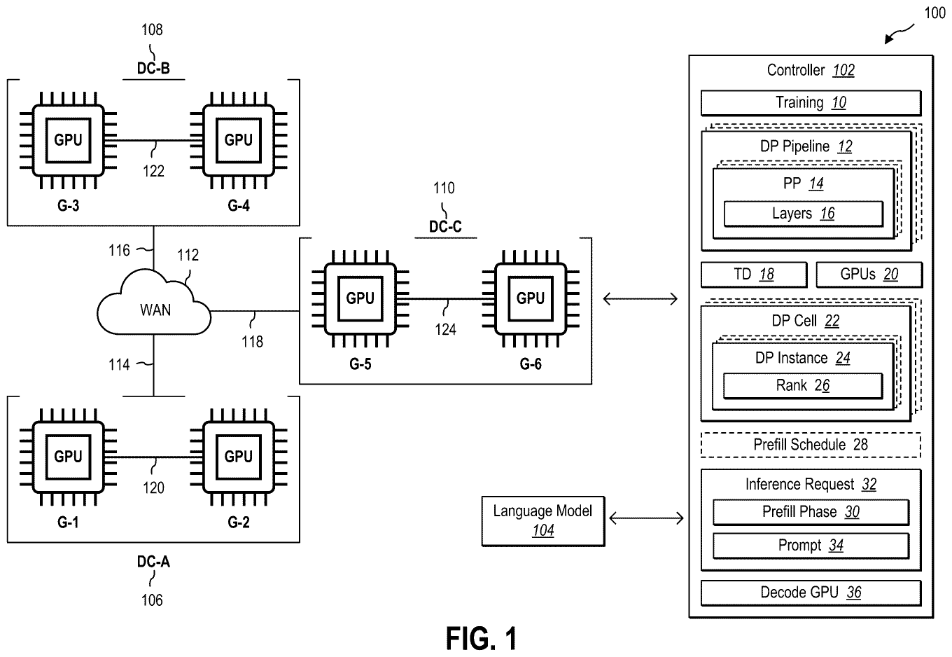

Referring now to FIG. 1, illustrated is an example environment 100 for geo-distributed training of language models. The environment 100 includes a controller 102 that facilitates training 10 of a language model 104. In some implementations, the language model 104 is a transformer based model where each transformer block comprises various components, including attention mechanisms and feedforward neural networks (FFNs), each containing its own neural network. Examples of the language model 104 include a Generative Pre-trained Transformer (GPT) model (e.g., GPT-3 or GPT-4), LlaMA, GEMINI, OPT, and Mistral. In some implementations, the controller 102 receives a request to initiate the training 10 of the language model 104. For example, a user provides a request to train the language model 104.

The controller 102 is in communication with a plurality of datacenters (e.g., the datacenter 106, the datacenter 108, the datacenter 110). In some implementations, the controller 102 is remote from the plurality of datacenters, for example, on a server or other computing device in communication with the datacenters. The server may include one or more computing devices (e.g., including processing units, data storage, etc.) organized in an architecture with various network interfaces for connecting to and providing data management and distribution across one or more client systems.

In some implementations, the datacenter 106 (DC-A), datacenter 108 (DC-B), and datacenter 110 (DC-C) are in communication with each other via a WAN 112. For example, the datacenter 106 communicates with the WAN 112 via a connection 114, the datacenter 108 communicates with the WAN 112 via the connection 116, and the datacenter 110 communicates with the WAN 112 via the connection 118. In some implementations, the connections 114, 116, and 118 are TCP connections. The WAN 112 may include one or multiple networks and may use one or more communication platforms and/or technologies suitable for transmitting data. The WAN 112 may refer to any data link that enables transport of electronic data between devices of the environment 100. The WAN 112 may refer to a hardwired network, a wireless network, or a combination of a hardwired network and a wireless network. The WAN 112 may be configured to facilitate communication between the various computing devices.

While three datacenters are illustrated, it should be appreciated that any number of datacenters may be included in the environment 100. Each datacenter includes a plurality of GPUs. Any number of GPUs may be included in the datacenters. For example, the datacenters include thousands of GPUs. In the example illustrated in the environment 100, the datacenter 106 includes GPU G1 and GPU G2 in communication via an intra-DC connection 120, the datacenter 108 includes GPU G3 and GPU G4 in communication via an intra-DC connection 122, and the datacenter 110 includes GPU G5 and GPU G6 in communication via an intra-DC connection 124. In some implementations, the intra-DC connections 120, 122, 124 have a higher bandwidth (illustrated with a thicker line) as compared to the connections 114, 116, 118 (illustrated with a thinner line).

In some implementations, the datacenters communicate with the WAN 112 using a plurality of connections. For example, the datacenter 106 communicates with the WAN 112 using the connection 114 and additional connections (not illustrated). Another example includes the datacenter 108 communicates with the WAN 112 using the connection 116 and additional connections (not illustrated). Another example includes the datacenter 110 communicates with the WAN 112 using the connection 118 additional connections (not illustrated). Using multiple connections (e.g., TCP connections) to communicate with the WAN 112 increase the bandwidth with the WAN 112 and improves the training time of a language model 104. For example, the bandwidth increases to 5 Gbps using multiple TCP connections between two nodes irrespective of distance between the nodes as compared to using 250 Mbps on a single TCP connection.

In some implementations, the controller 102 uses 3D parallelism for the training 10 of the language model 104. The controller 102 determines data parallel pipelines 12 for the training 10. Each data parallel pipeline 12 contains parallel pipelines 14 where subsets of layers 16 are assigned to individual GPUs 20 by the controller 102.

In some implementations, the data parallel pipeline 12 runs across GPUs 20 in different datacenters. One example includes the training 10 has six layers and the controller 102 assigns the parallel pipelines 14 across six GPUs (e.g., GPU G-1 and GPU G-2 in the datacenter 106, GPU G-3 and GPU G-4 in the datacenter 108 and the GPU G-5 and the GPU G-6 in the datacenter 110). Each GPU is assigned one layer. For different data parallel pipelines 12, each layer 16 is assigned in the same datacenter. The all-reduce ring that runs for each layer 16 runs across nodes in the same datacenter. In some implementations, the tensor parallelism is assigned by the controller 102 across GPUs 20 on the same node (or nodes in the same datacenter).

In some implementations, the controller 102 uses a heuristic that calculates a schedule for forward and backward passes for the training 10 of the language model 104. The controller 102 precomputes the schedule prior to starting the training 10 and may adjust the schedule as needed once the training 10 begins. The controller 102 groups data parallel instances 24 into data parallel cells 22 during the initialization phase of the training 10. Data parallel instances 24 within a data parallel cell 22 coordinates usage of the aggregate WAN bandwidth. Each data parallel cell 22 operates independent of each other. Each data parallel instance 24 in a data parallel cell 22 is assigned a rank 26 and the aggregate WAN bandwidth is shared temporally between the data parallel instances 24 based on the rank 26 of the data parallel instances 24. The WAN 112 communication is slower than compute resulting in bubbles between micro-batches. In some implementations, the controller 102 sets the number of data parallel pipelines 12 in a data parallel cell 22 to a communication to compute ratio to eliminate bubbles.

In some implementations, the controller 102 schedules the compute phase of a micro-batch in a data parallel pipeline 12 at a time when a communication phase may be scheduled immediately next, without overlapping with the communication phase of any other already generated schedule. In case of contention, the controller 102 reschedules the compute phase for the micro-batch to ensure the communication phase does not overlap with any other network communication in the same data parallel cell facilitating bubble consolidation.

In some implementations, if a recompute has completed for a stage of a micro-batch, the controller 102 waits for the corresponding backward pass for the micro-batch to be scheduled. If a stage of a micro-batch has both forward and backward tasks ready to be scheduled, the controller 102 prioritizes the backward pass to unlock processing at subsequent nodes.

In some implementations, the controller 102 determines an optimal number of GPUs 20 from individual datacenters that maximize training throughput and reduce training latency. In some implementations, users may run a simulation to understand an impact on cost and performance of varying a number of GPUs selected in multiple datacenters in determining a number of GPUs 20 to use for training 10 the language model 104. In some implementations, the controller 102 maximizes a number of GPUs 20 used in a same data center and tries to minimize the number of datacenters used for the training 10.

In some implementations, the controller 102 uses an algorithm to calculate the training latency and uses the training latency in determining an optimal number of GPUs 20 in individual datacenters. An example algorithm that the controller 102 uses to calculate the training latency is illustrated below in Algorithm 1.

Algorithm 1

```
INPUT: Dₘₐₓ, DCs, Num_GPU, C, P
OUTPUT: total_time
  1: for D in {1 to Dₘₐₓ} do
  2: part_left = P;
  3: for dc in DCs do
  $4 \text{:} PP\_GPU = ⌊ \frac{Num\_BPU [ dc ]}{D \cdot C} ⌋ ;$
  5: part_assigned = min(part_left, PP_GPU);
  6: Partitions[dc] = part_assigned;
  7: part_left− = part_assigned;
  8: if part_left = = 0 then break;
  9: end if
10: end for
11: if part_left > 0 then
12: PP_time = ∞
13: else
14: PP_time = get_latency_pp(Partitions, D);
15: all_reduce_time = get_latency_dp(D · C);
16: end if
17: total_time[D] = PP_time + all_reduce_time;
18: end for
```

The inputs to the algorithm include: (a) an implicit ordering of the datacenters (DCs) (e.g., based on cost of GPUs where the default is based on decreasing order of GPU availability), (b) the number of available GPUs in each datacenter (Num_GPU), (c) maximum number of data parallel cells (Dₘₐₓ), (d) communication to compute ratio (C) for pipeline parallelism, and (e) a maximum number of partitions (P). P is the ratio of total layers in a language model 104 to the number of layers fit on a language model due to resources on GPU (e.g., GPU memory). Smaller partitions see smaller pipeline parallelism communication overhead. The output of Algorithm 1 is the total time for different values of data parallel cells (D). In some implementations, a user determines D depending on cost, performance, and other metrics. For example, Dₘₐₓ is set to the sum of the available GPUs in each datacenter (Num_GPU) divided by the communication ratio (C) multiplied by the maximum number of partitions (P).

Algorithm 1 calculates the total training time of an iteration for each value (D) of data parallel cell [1,Dₘₐₓ] that includes the time for running pipeline parallel and all-reduce in data parallel. The compute time (including tensor parallelism, if any) is constant across D and is ignored by Algorithm 1. Algorithm 1 iterates the datacenters in an order based on cost, distance, or other metrics (line 3 of Algorithm 1). Algorithm 1 calculates the number of GPUs for the pipeline parallelism as the available GPUs in a datacenter (Num_GPU [dc]) divided by D multiplied by C, as there are D data parallel cells each with C individual data parallel pipelines (line 4 of Algorithm 1). Algorithm 1 assigns the number of partitions based on a minimum of partitions left and a number of GPUs in pipeline parallelism calculated (line 5 of Algorithm 1).

Algorithm 1 stores the GPUs assigned in the partitions mapping (line 6 of Algorithm 1) and adjusts the partitions left (line 7 of Algorithm 1). The iteration of the datacenters ends when all partitions are assigned, or GPUs are unavailable (lines 8-12 of Algorithm 1). Algorithm 1 calculates the total execution time for a given D (lines 14-17 of Algorithm 1). The latency for temporal bandwidth sharing for a data parallel cell is calculated (get_latency_pp of Algorithm 1) and the latency of the all-reduce phase across data parallel pipelines is calculated (get_latency_dp of Algorithm 1).

In some implementations, the controller 102 uses Algorithm 1 in determining the smallest D (GPUs) that provides the highest throughput. For example, the throughput is calculated using the equation (1).

$$throughput = \frac{D \cdot C}{total\_time [ D ]} \qquad ( 1 )$$

The controller 102 uses the number of GPUs determined from Algorithm 1 for training 10 the language model 104. The environment 100 improves the training time of training language models by using GPUs distributed across different data centers for the training 10 of the language models 104.

In some implementations, the controller 102 determines a prefill schedule 28 to schedule a prefill phase 30 of an inference request 32 during a compute bubble (e.g., an idle time) of a GPU 20 selected for the training 10 of the language model 104. Scheduling the prefill phase 30 of an inference request 32 during an idle time of the GPU 20 improves the GPU utilization in training clusters.

In some implementations, the controller 102 receives a prompt 34 of an inference request 32 and a decode GPU 36 selected to process a decode phase of the inference request 32. For example, the controller 102 receives the prompt 34 and the decode GPU 36 from an inference controller in communication with the controller 102. The controller 102 determines an estimated executed time to complete a prefill phase 30 of the inference request 32 based on the input prompt 34 of the inference request 32. The controller 102 identifies GPU compute bubbles in GPUs selected for the training 10 of the language model 104 and selects a GPU 20 with a compute bubble with enough capacity to process the prefill phase 30 before the training resumes. After completion of the prefill phase 30, the controller 102 transfers a key-value (KV) cache to the decode GPU 36 for the decode phase of the inference request 32.

In some implementations, the controller 102 determines the prefill schedule 28 by forming a parallel pipeline across GPUs in the same datacenter. For example, the prefill schedule 28 has the same rank 26 as individual data parallel cells in the same datacenter. The controller 102 identifies an available pipeline parallel pipeline in the datacenter with a bubble across the GPUs to accommodate the prefill phase 30. In some implementations, the controller 102 is unable to identify a GPU selected for the training 10 of the language with a bubble long enough to complete the prefill phase 30 prior to the training 10 resuming. For example, the training 10 is ongoing and there is no bubble with enough time to accommodate the prefill phase 30. The controller 102 notifies the inference controller that the training cluster is in use and is unavailable for processing the prefill phase 30. The environment 100 improves the usage of GPUs in training clusters by scheduling the prefill phase 30 of an inference request 32 during idle times of GPUs selected for training language models.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the controller 102 and the language model 104 is implemented on a single computing device. Moreover, in some implementations, one or more subcomponent of the feature and functionalities discussed herein may be implemented are processed on different server devices of the same or different cloud computing networks. For example, the controller 102 and the language model 104 are implemented on different server devices.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

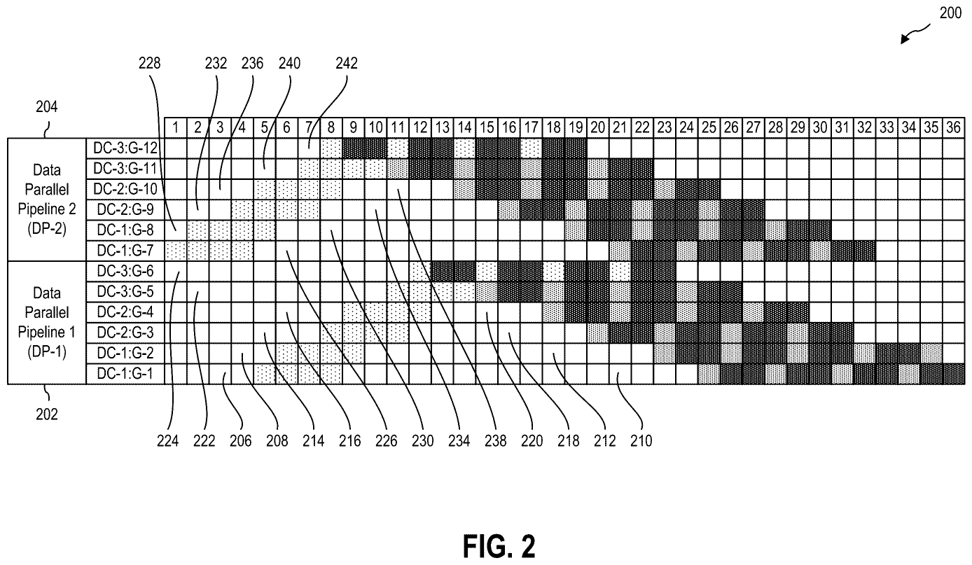

FIG. 2 illustrates an example timing diagram 200 of temporal bandwidth sharing across data parallel pipelines 202, 204. The x-axis of the timing diagram illustrates the timeslots, and the y-axis illustrates the different datacenters and GPUs selected for the data parallel pipelines 202, 204.

In the illustrated example, the controller 102 (FIG. 1) selects the datacenters (DC-1, DC-2, DC-3) and the GPUs (GPU G-1, GPU G-2, GPU G-3, GPU G-4, GPU G-5, GPU G-6, GPU G-7, GPU G-8, GPU G-9, GPU G-10, GPU G-11, and GPU G-12) for training 10 (FIG. 1) the language model 104 (FIG. 1). For example, the training 10 job for the language model 104 (FIG. 1) has six layers and the controller 102 assigns the data parallel pipelines 202, 204 across six GPUs. The controller 102 assigns the GPUs G-1 and G-2 of the DC-1, the GPUs G-3 and G-4 of the DC-2, and the GPUs G-5 and G-6 of the DC-3 for the data parallel pipeline 202. The controller 102 assigns the GPUs G-7 and G-8 of the DC-1, the GPUs G-9 and G-10 of the DC-2, and the GPUs G-11 and G-12 of the DC-3 for the data parallel pipeline 204. Each GPU is assigned one layer.

For the different data parallel pipelines, each layer is assigned in the same datacenter. For example, layer-1 is assigned to GPUs G-1 and G-2 in the datacenter DC-1 and layer-2 is assigned to GPUs G-5 and G-6 in the datacenter G-3. The all-reduce ring that runs for each layer runs across nodes in the same datacenter.

The timing diagram 200 illustrates micro-batches (M1, M2, M3, M4) of the data parallel pipelines 202, 204 and the forward, recompute, and backward passes. Each of the data parallel pipelines 202, 204 starts with a forward pass starting on the left of the x-axis followed by the backward pass. In some implementations, the controller 102 uses a heuristic that calculates a schedule for the forward and backward passes for the data parallel pipelines 202, 204. For example, the controller 102 computes the schedule prior to starting of the training 10.

The controller 102 coordinates usage of the aggregate WAN bandwidth (e.g., the available bandwidth of the WAN 112 (FIG. 1)) among the data parallel pipelines 202, 204. Each data parallel pipeline operates independent of each other. In some implementations, each of the data parallel pipelines 202, 204 is assigned a rank 26 (FIG. 1) and the aggregate WAN bandwidth is shared temporally between the data parallel pipelines 202, 204 based on the rank 26. For example, the data parallel pipeline 204 is assigned a higher rank 26 than the rank 26 assigned to the data parallel pipeline 202 and the data parallel pipeline 204 uses the available WAN bandwidth first in a datacenter to process the forward pass for the data parallel pipeline 204. Upon the completion of the processing in a datacenter of the forward pass for the data parallel pipeline 204, the forward pass for the data parallel pipeline 202 starts in the datacenter using the available WAN bandwidth. Instead of splitting the available bandwidth between the data parallel pipelines 202, 204, the controller 102 schedules the use of the aggregate WAN bandwidth for each data parallel pipeline individually. The WAN 112 communication is slower than compute resulting in bubbles between micro-batches. In some implementations, the controller 102 sets the number of data parallel pipelines to a communication to compute ratio to eliminate bubbles. Coordinating usage of the aggregate WAN bandwidth (e.g., the available bandwidth of the WAN 112 (FIG. 1)) among the data parallel pipelines 202, 204 improves the training time of the language model 104.

In some implementations, the controller 102 when scheduling forward passes for a micro-batch on any data parallel pipeline, filters the forward passes for which activations/gradients in memory at any point of time at any stage in the pipeline is within the peak memory limit. The controller 102 prevents blocking computation and communication phases on other data parallel pipelines because of unnecessary utilization of the aggregate WAN bandwidth for transmitting activations/gradient that would result in exceeding peak memory limits.

In some implementations, the controller 102 schedules the compute phase of a micro-batch in a data parallel pipeline at a time only when a communication phase may be scheduled immediately next, without overlapping with the communication phase of any other already generated schedule. In case of contention, the controller 102 reschedules the compute phase for the micro-batch to ensure the communication phase does not overlap with any other network communication in the same data parallel cell facilitating bubble consolidation.

In some implementations, if a recompute has completed for a stage of a micro-batch, the controller 102 waits for the corresponding backward pass for the micro-batch to be scheduled. If a stage of a micro-batch has both forward and backward tasks ready to be scheduled, the controller 102 prioritizes the backward pass to unlock processing at subsequent nodes.

In some implementations, the controller 102 determines compute bubbles (e.g., an idle time) of a GPU selected for the training 10 of the language model 104 is going to occur in response to the schedule determined for the temporal bandwidth sharing of the WAN bandwidth. In some implementations, the controller 102 determines a prefill schedule 28 (FIG. 1) to schedule a prefill phase 30 (FIG. 1) of an inference request 32 (FIG. 1) during a compute bubble (e.g., an idle time) of a GPU selected for the training 10 of the language model 104. The controller 102 identifies GPU compute bubbles in GPUs selected for the training 10 of the language model 104 and selects a GPU 20 with a compute bubble with enough capacity to process the prefill phase 30 before the training resumes.

For example, the controller 102 determines a bubble 206 and a bubble 210 for GPU G-1 of DC-1, a bubble 208, 212 for GPU G-2 of DC-1, a bubble 214 and a bubble 218 for GPU G-3 of DC-2, a bubble 216 and a bubble 220 for GPU-G-4 of DC-2, a bubble 222 for GPU-5 of DC-3 and a bubble 224 for GPU-6 of DC-3, a bubble 226 for GPU-7 of DC-1, a bubble 228 and a bubble 230 for GPU-8 of DC-1, a bubble 232 and a bubble 234 for GPU-9 of DC-2, a bubble 236 and a bubble 238 for GPU-10 of DC-2, a bubble 240 for GPU-11 of DC-3, and a bubble 242 for GPU-12 of DC-3. One example includes the controller 102 determines the bubble 224 has enough capacity to process the prefill phase 30 before training resumes and uses the GPU G-6 in DC-3 to process the prefill phase 30 for the inference request 32.

Another example includes the controller 102 determines the bubbles 210 and 212 have enough capacity to process the prefill phase 30 before training resumes and uses the GPUs G-1 and G-2 in DC-1 to process the prefill phase 30 for the inference request 32. Another example includes the controller 102 determines the bubbles 214 and 216 have enough capacity to process the prefill phase 30 before training resumes and uses the GPUs G-3 and G-4 in DC-2 to process the prefill phase 30 for the inference request 32.

In some implementations, the controller 102 receives a plurality of inference requests 32 and uses the prefill schedule 28 to schedule the prefill phases 30 for the inference requests 32 one-by-one during the bubbles. For example, a first prefill phase for a first inference request is assigned to the bubble 208, a second prefill phase for a second inference request is assigned to the bubble 216, a third prefill phase for a third inference request is assigned to the bubble 224, a fourth prefill phase for a fourth inference request is assigned to the bubble 226, and a fifth prefill phase for a fifth inference request is assigned to the bubble 210. If some of the inference requests 32 received are unable to fit in a bubble (e.g., a sixth prefill phase for a sixth inference request), the controller 102 returns a false for the inference requests 32 that are unable to fit in a bubble. Scheduling the prefill phase 30 of an inference request 32 during idle times of GPUs selected for training language models improves the usage of GPUs in the training clusters.

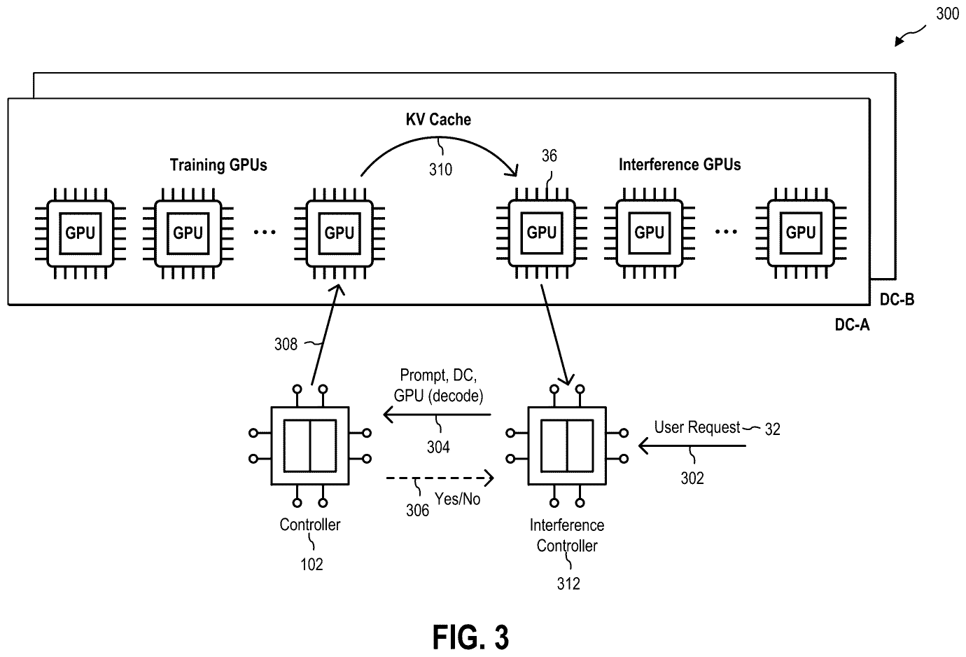

FIG. 3 illustrates example environment 300 for scheduling prefill phases 30 (FIG. 1) of inference requests 32. The environment 300 includes an inference controller 312 in communication with a set of inference GPUs in datacenters (e.g., DC-A and DC-B). In some implementations, the inference controller 312 is in communication with the controller 102 that is in communication with a set of training GPUs in the datacenters (e.g., DC-A and DC-B).

At 302, the inference controller 312 receives the inference request 32 from a user. The inference controller 312 chooses a datacenter (e.g., DC-A) to process the inference request 32. At 304, the controller 102 receives the prompt, the datacenter, and the details for the decode GPU 36 for processing the decode of the inference request 32. At 306, the controller 102 notifies the inference controller 312 whether a training GPU has capacity (e.g., an idle GPU) to process the prefill phase 30 of the inference request 32. If the training GPUs do not have enough capacity to process the prefill phase 30 (e.g., the training is ongoing and there is no bubble at that time), the controller 102 informs the inference controller 312.

At 308, the controller 102 uses a prefill schedule 28 to schedule the prefill phase 30 of the inference request 32 on the training GPU with enough capacity and time ahead (e.g., a bubble with enough time to complete the prefill phase 30 prior to training resuming). The controller 102 receives signals from the individual training GPUs when the training GPUs process micro-batches and the controller 102 assigns the prefill phase 30 during bubbles in response to receiving the signals from the training GPUs. In some implementations, the controller 102 identifies timeslots where the training GPUs are idle. In some implementations, the controller 102 finds a first available parallel pipeline that has bubble across GPUs (e.g., the training GPUs are idle during a timeslot) to accommodate the prefill phase 30 using pipeline parallelism to increase the inferencing time to first token marginally without an impact on time between tokens.

At 310, the controller 102 transfers the KV cache to the decode GPU 36. After the completion of the prefill phase 30, the KV cache is transferred to the decode GPU 36 (e.g., the GPU specified by the inference controller for the decode phase of the inference request 32). Scheduling the prefill phase 30 of an inference request 32 during idle times of the training GPUs for training language models improves the usage of the training GPUs.

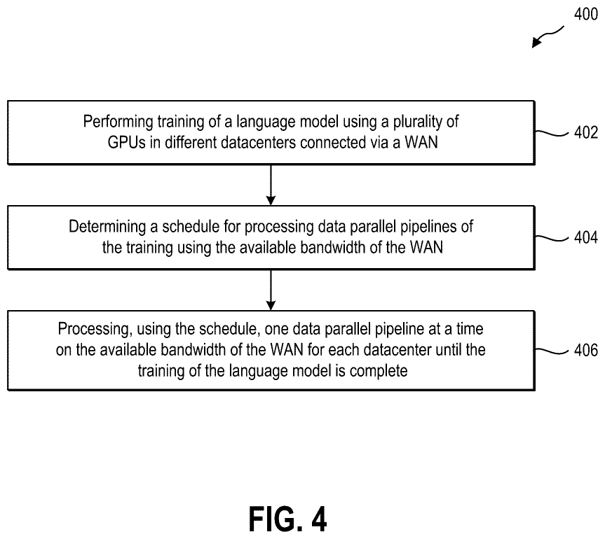

FIG. 4 illustrates an example method 400 for geo-distributed training of language models. The actions of the method 400 are discussed below in reference to FIGS. 1-3.

At 402, the method 400 includes performing training of a language model using a plurality of GPUs in different datacenters connected via a WAN. In some implementations, the controller 102 performs the training 10 of a language model 104 using a plurality of GPUs 20 in different datacenters (e.g., the datacenters 106, 108, 110) connected via a WAN 112. In some implementations, the training 10 includes data parallelism, pipeline parallelism, and tensor parallelism and the plurality of GPUs 20 are used across the data parallelism, the pipeline parallelism, and the tensor parallelism. In some implementations, the number of transmission control protocol (TCP) connects are increased from the datacenters to the WAN 112 and the controller 102 processes the data parallel pipelines of the training 10 using the TCP connections.

At 404, the method 400 includes determining a schedule for processing data parallel pipelines of the training using available bandwidth of the WAN. In some implementations, the controller 102 determines a schedule for processing the data parallel pipelines (e.g., the data parallel pipelines 12, the data parallel pipeline 202, the data parallel pipeline 204) using the available bandwidth of the WAN 112. In some implementations, the controller 102 determines the schedule using a rank 26 of each data parallel pipeline.

In some implementations, each data parallel pipeline includes parallel pipelines (e.g., the parallel pipelines 14) with a subset of layers (e.g., the layers 16) of the language model 104 assigned to individual GPUs 20 across different datacenters. For example, the controller 102 assigns individual GPUs 20 across different datacenters to each layer 16 of the language model 104. In some implementations, each layer 16 of the language model 104 is assigned to individual GPUs 20 in a same datacenter.

In some implementations, the controller 102 uses an algorithm (e.g., Algorithm 1) to determine a number of datacenters to use during training 10 of the language model 104 and a number of GPUs 20 to use in each datacenter to use during training 10 of the language model 104. In some implementations, the algorithm selects a smallest number of datacenters and GPUs 20 that maximize training throughput while reducing communications over the WAN 112.

At 406, the method 400 includes processing, using the schedule, one data parallel pipeline at a time on the available bandwidth of the WAN for each datacenter until the training of the language model is complete. In some implementations, the controller 102 processes, using the schedule, one data parallel pipeline (e.g., the data parallel pipeline 202, the data parallel pipeline 204) at a time on the available bandwidth of the WAN 112.

In some implementations, the controller 102 receives an inference request 32 with a prompt 34 and details of a decode GPU 36 for a decode phase of the inference request 32. The controller 102 identifies a timeslot with an idle GPU during the training 10 of the language model 104. The controller 102 determines based on the prompt 34 an estimated time for processing the prefill phase 30 and whether the timeslot can process a prefill phase 30 of the inference request 32 prior to the training 10 resuming on the idle GPU. In some implementations, the controller 102 processes, using the prefill schedule 28, the prefill phase 30 in the timeslot in response to determining that the timeslot can process the prefill phase 30 and transfers a cache to the decode GPU 36 to perform the decode phase of the inference request 32 upon completion of processing the prefill phase 30. In some implementations, the controller 102 sends a notification that the training 10 is ongoing and that the plurality of GPUs 20 are unavailable to process the prefill phase 30.

The method 400 improves the training time of training language models by using GPUs 20 distributed across different data centers for the training 10 of the language models 104.

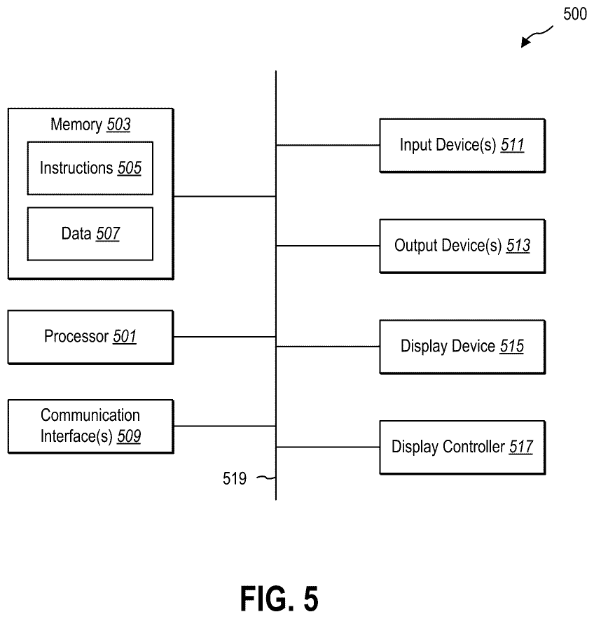

FIG. 5 illustrates components that may be included within a computer system 500. One or more computer systems 500 may be used to implement the various methods, devices, components, and/or systems described herein.

The computer system 500 includes a processor 501. The processor 501 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

In some implementations, the various components of the computer system 500 are implemented as one device. For example, the various components of the computer system 500 are implemented in a mobile phone or tablet. Another example includes the various components of the computer system 500 implemented in a personal computer. Another example includes the various components of the computer system 500 implemented in the cloud. Another example includes the various components of the computer system 500 implemented on an edge device.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model, a probabilistic graphical model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method comprising:
performing training of a language model using a plurality of graphics processing units (GPU) s in different datacenters connected via a wide area network (WAN);
determining a schedule for processing data parallel pipelines of the training using available bandwidth of the WAN; and
processing, using the schedule, one data parallel pipeline at a time on the available bandwidth of the WAN for each datacenter until the training of the language model is complete.

2. The method of claim 1, wherein the training includes data parallelism, pipeline parallelism, and tensor parallelism and the plurality of GPUs are used across the data parallelism, the pipeline parallelism, and the tensor parallelism.

3. The method of claim 1, wherein the scheduled is determined using a rank of each data parallel pipeline.

4. The method of claim 1, further comprising:
increasing a number of transmission control protocol (TCP) connections from the datacenters to the WAN; and
processing, using the TCP connections, the data parallel pipelines of the training.

5. The method of claim 1, wherein each data parallel pipeline includes parallel pipelines with a subset of layers of the language model assigned to individual GPUs across different datacenters.

6. The method of claim 5, wherein each layer of the language model is assigned to individual GPUs in a same datacenter.

7. The method of claim 1, further comprising:
determining, using an algorithm, a number of datacenters to use during training of the language model; and
determining, using the algorithm, a number of GPUs to use in each datacenter to use during training of the language model.

8. The method of claim 7, wherein the algorithm selects a smallest number of datacenters and GPUs that maximize training throughput while reducing communications over the WAN.

9. The method of claim 1, further comprising:
receiving an inference request with a prompt and details of a decode GPU for a decode phase of the inference request;
identifying a timeslot with an idle GPU during the training of the language model; and
determining based on the prompt whether the timeslot can process a prefill phase of the inference request prior to the training resuming on the idle GPU.

10. The method of claim 9, further comprising:
processing, using a prefill schedule, the prefill phase in the timeslot in response to determining that the timeslot can process the prefill phase; and
transferring a key-value (KV) cache to the decode GPU to perform the decode phase of the inference request upon completion of processing the prefill phase.

11. The method of claim 9, further comprising:
sending a notification that the training is ongoing and that the plurality of GPUs are unavailable to process the prefill phase.

12. A device comprising:
a memory to store data and instructions; and
a processor operable to communicate with the memory, wherein the processor is operable to:
perform training of a language model using a plurality of graphics processing units (GPU) s in different datacenters connected via a wide area network (WAN);
determine a schedule for processing data parallel pipelines of the training using available bandwidth of the WAN; and
process, using the schedule, one data parallel pipeline at a time on the available bandwidth of the WAN for each datacenter until the training of the language model is complete.

13. The device of claim 12, wherein the scheduled is determined using a rank of each data parallel pipeline.

14. The device of claim 12, wherein the processor is further operable to:
increase a number of transmission control protocol (TCP) connections from the datacenters to the WAN; and
process, using the TCP connections, the data parallel pipelines of the training.

15. The device of claim 12, wherein each data parallel pipeline includes parallel pipelines with a subset of layers of the language model assigned to individual GPUs across different datacenters.

16. The device of claim 15, wherein each layer of the language model is assigned to individual GPUs in a same datacenter.

17. The device of claim 12, wherein the processor is further operable to:
determine, using an algorithm, a number of datacenters to use during training of the language model; and
determine, using the algorithm, a number of GPUs to use in each datacenter to use during training of the language model.

18. The device of claim 17, wherein the algorithm selects a smallest number of datacenters and GPUs that maximize training throughput while reducing communications over the WAN.

19. The device of claim 12, wherein the processor is further operable to:
receive an inference request with a prompt and details of a decode GPU for a decode phase of the inference request;
identify a timeslot with an idle GPU during the training of the language model; and
determine based on the prompt whether the timeslot can process a prefill phase of the inference request prior to the training resuming on the idle GPU.

20. The device of claim 19, wherein the processor is further operable to:
process, using a prefill schedule, the prefill phase in the timeslot in response to determining that the timeslot can process the prefill phase; and
transfer a key-value (KV) cache to the decode GPU to perform the decode phase of the inference request upon completion of processing the prefill phase.
